(19) United States
(12) Patent Application Publication
(10) Pub. No.: US 2026/0219113 A1
(43) Pub. Date: Jul. 30, 2026

(54) TEMPERATURE MEASUREMENT DEVICE FOR FOOD MATERIAL

(71) Applicant: SHENZHEN TYPHUR TECHNOLOGY CO., LTD, Shenzhen (CN)

(72) Inventors: Kaige LUO, Shenzhen (CN); Jie FENG, Shenzhen (CN)

(73) Assignee: SHENZHEN TYPHUR TECHNOLOGY CO., LTD, Shenzhen (CN)

(21) Appl. No.: 19/148,907

(22) PCT Filed: Sep. 5, 2023
(86) PCT No.: PCT/CN2023/116889

§ 371 Date: Jul. 17, 2025

(30) Foreign Application Priority Data
Jan. 17, 2023 (WO) PCT/CN2023/072750

(51) Int. Cl. G01K 13/00; G01K 1/12; G01K 1/14; G01K 1/16

(52) U.S. Cl. CPC G01K 13/00; G01K 1/12; G01K 1/14; G01K 1/16

(57) ABSTRACT

A temperature measurement device comprising a housing and multiple food temperature detection units defined in the housing, the extension section of the housing is divided by a longitudinal reference plane passing through its centerline into a first longitudinal portion and a second longitudinal portion; the first longitudinal portion and the second longitudinal portion each correspond to at least one first temperature detection unit configured to collect temperature information corresponding to the respective regions of the first and second longitudinal portions; when the temperature measurement device is inserted into the interior of food, the first and second longitudinal portions face different regions inside the food, and the first temperature detection units corresponding to the first and second longitudinal portions respectively detect the temperatures of these different regions, thereby obtaining temperature information of different regions to improve detection of the lowest temperature inside the food.

### TECHNICAL FIELD

The present invention relates to the field of food cooking, specifically to a temperature measurement device used for detecting the temperature of food.

### BACKGROUND ART

With the advancement of technology and the increasing demands of people regarding the taste and nutrition of food, there is a growing expectation for more precise control of temperature elements during the cooking process. For instance, more accurate control of the temperature of the food and the temperature of the heating water is desired. Therefore, a temperature measurement device applied in the cooking of food has emerged.

In meat or other similar foods, there is often a significant difference between the surface temperature and the internal temperature, especially since the temperature at the center of the food is usually the lowest. In order to detect the temperature near the center of the food, the temperature measurement device is usually designed with an insertable structure, such as a needle-like structure, so that it can be inserted into the food to measure the internal temperature (such as the center region). However, due to the irregular shape of food and the difficulty in accurately placing the temperature measurement device during use, users are often unable to accurately insert the device into the center region of the food, making it difficult to obtain the lowest temperature at the center of the food.

To improve the accuracy of detecting the internal temperature of food, some temperature measurement devices are equipped with multiple temperature sensors arranged longitudinally along the needle-like structure. This increases the number of temperature measurement points on the temperature measurement device, allowing the minimum internal temperature of the food to be determined based on the temperature data collected by these sensors. However, due to the large variations in internal temperature within food, there may be significant temperature differences even between adjacent regions inside the food. The existing arrangement of temperature sensors in conventional temperature measurement devices has flaws, resulting in a significant discrepancy between the detected minimum temperature and the actual minimum internal temperature of the food, leading to inaccurate results.

### SUMMARY OF THE INVENTION

The present invention primarily provides a temperature measurement device for food, showcasing a new structure for temperature detection inside food.

Based on the above objective, in one embodiment, this application provides a temperature measurement device for food, comprising:

A housing, wherein the housing comprises a detection portion in contact with the food, the housing forming an installation cavity, with at least a part of the cavity defined in the detection portion. The detection portion is elongated and comprises a front end and an extension section connected to the rear side of the front end.

A control circuit board, which is defined within the installation cavity.

A plurality of food temperature detection units, the food temperature detection units being defined within the housing, with each unit having a sensing end for collecting temperature data. At least some of the food temperature detection units are first temperature detection units, which are defined in the extension section. These first temperature detection units are electrically connected to the control circuit board to transmit the detected signals to the control circuit board.

The extension section is divided into a first longitudinal portion and a second longitudinal portion by a longitudinal reference plane passing through its central axis. Each longitudinal portion corresponds to at least one first temperature detection unit, to collect temperature information from the respective regions of the first and second longitudinal portions.

In one embodiment, the control circuit board extends longitudinally along the detection portion, with the longitudinal reference plane being parallel to or coincident with the control circuit board. The control circuit board contains a control circuit electrically connected to the food temperature detection units.

In another embodiment, the control circuit board has a first side and a second side that face away from each other, with electronic components of the control circuit placed on one or both sides. The longitudinal reference plane is parallel to or coincident with the first or second side.

In one embodiment, the projection of the sensing end of some of the first temperature detection units on the cross-section of the detection portion falls within the projection range of the space extending from the first side to the second side. The projection of other first temperature detection units on the cross-section of the detection portion falls within the space extending from the second side to the first side.

In one embodiment, some of the first temperature detection units are defined on the first side, while others are defined on the second side.

In one embodiment, the first temperature detection units are at least two, arranged longitudinally along the extension section, with the first temperature detection units defined at different positions along the longitudinal axis.

In one embodiment, the first temperature detection units for detecting the temperature information from the first longitudinal portion consists of at least two units, and/or the first temperature detection units for detecting the temperature information from the second longitudinal portion consists of at least two units. The projections of the first temperature detection units on the cross-section of the extension section are completely or partially staggered or do not overlap.

In one embodiment, at least part of the projections of the first temperature detection units are arranged to encircle the center of the cross-section of the extension section.

In one embodiment, the projections of two adjacent first temperature detection units on the cross-section form a central angle with the center of the cross-section, where the central angle is between 85° and 95°.

In one embodiment, at least part of the projections of the first temperature detection units on the cross-section encircle the center of the cross-section, and the projections of any two adjacent first temperature detection units on the cross-section form equal central angles with the center of the cross-section.

In one embodiment, at least four first temperature detection units are arranged on the cross-section of the extension section, with the projections of the four units encircling the center of the cross-section, and the central angle formed by the projections of adjacent units is 90°.

In one embodiment, some of the food temperature detection units are second temperature detection units defined in the front end portion, designed to detect the temperature of the front end portion of the food.

In one embodiment, the projections of the second temperature detection units on the cross-section coincide with the center of the cross-section.

In one embodiment, at least one food temperature detection unit is separately defined within a housing cavity, with the cavity wall isolating this food temperature detection unit from others. The cavity wall and the longitudinal structure of the detection portion form a thermal isolation structure to prevent heat from adjacent regions from affecting the food temperature detection unit.

In one embodiment, the cavity wall, excluding the portion facing the detection portion, forms a thermal isolation structure around the food temperature detection unit within the housing cavity.

In one embodiment, the device also comprises a front end mounting base, which is defined inside the detection portion, with at least a part of the front end mounting base defined within the front end portion, wherein at least one front accommodating cavity is formed between the front end of the front end mounting base and the front end portion, and one second temperature detecting unit is arranged in each front accommodating cavity.

In one embodiment, at least one lateral accommodating cavity is formed between a peripheral side of the front end mounting base and the front end portion, and one first temperature detecting unit is arranged in each lateral accommodating cavity.

In one embodiment, in the cross section of the extension section, the projection of at least one first temperature detecting unit defined in a lateral accommodating cavity completely overlaps, partially overlaps, or is completely staggered with the projection of at least one second temperature detecting unit defined in a front accommodating cavity.

In one embodiment, the front end mounting base provides elastic support to the second temperature detection unit or part of the first temperature detection units, forming a thermal conduction structure between the second temperature detection unit or part of the first temperature detection units and the detection portion.

In one embodiment, the front end mounting base has a first mounting groove at its front end, within which the second temperature detection unit is defined, and the first mounting groove and the front end portion form a front accommodating cavity.

In one embodiment, a peripheral side of the front end mounting base has at least one second mounting groove, the one first temperature detecting unit is defined in the second mounting groove, and the lateral accommodating cavity is formed between the second mounting groove and the extension section.

In one embodiment, the device further comprises at least one intermediate mounting base, which is defined within the extension section, the intermediate mounting base and a corresponding side wall of the extension section form a peripheral accommodating cavity, and one first temperature detecting unit is arranged in each peripheral accommodating cavity.

In one embodiment, the intermediate mounting base provides elastic support to the first temperature detection unit, forming a thermal conduction structure between the first temperature detection unit and the extension section.

In one embodiment, the intermediate mounting base has a third mounting groove, where at least part of the first temperature detection units are defined, the peripheral accommodating cavity is formed between the third mounting groove and the extension section.

In one embodiment, the device comprises at least two intermediate mounting bases, arranged longitudinally along the extension section, with gaps between adjacent intermediate mounting bases. The control circuit board passes through the intermediate mounting bases along the longitudinal axis.

In one embodiment, at least the portion of the front end mounting base and/or middle mounting base used to form a corresponding accommodation cavity is made of thermal insulation material.

In one embodiment, the insulating material comprises an elastic, heat-resistant silicone, rubber, or resin.

In one embodiment, at least some of the food temperature detection units form an elastic support structure, so that the at least a part of the food temperature detection units form a thermal conduction structure with the extension section.

In one embodiment, in the thermal conduction structure, the at least a part of food temperature detection units are directly in contact with an inner wall of the detection portion, or a thermally conductive material is set between the the at least a part of food temperature detection units and the inner wall of the detection portion, with the at least a part of food temperature detection units, the thermal conduction material, and the detection portion in mutual abutting.

In one embodiment, the elastic support structure drives the food temperature detection unit into contact with the thermal conduction material or the detection portion via elastic components.

In one embodiment, the thermal conduction material comprises heat-conductive silicone grease, thermally conductive silicone, thermally conductive rubber, thermal gel, or thermal film.

In one embodiment, at least some of the food temperature detection units are defined on the control circuit board, while others are separated from the control circuit board and form a thermal conduction structure with the inner wall of the extension section.

In one embodiment, the extension section has a safety zone marker. The area from the front end of the front end portion to the safety zone marker is designated as a safe zone, where the food temperature detection units are defined.

In one embodiment, the device also includes a power supply battery, which is defined within the detection portion, within the safe zone.

In one embodiment, the control circuit board is defined within the safe zone, with the power supply battery placed in front of the control circuit board along the longitudinal axis.

In one embodiment, the device also comprises an ambient temperature detection unit, which is defined within the handle portion of the housing and welded to the control circuit board. The welding point is defined outside the safe zone.

In one embodiment, the device comprises an antenna, which is spirally shaped and defined within the handle portion. The ambient temperature detection unit passes through the hollow area of the spiral structure.

In one embodiment, the device comprises an antenna in the form of a board structure, and a spacer is arranged between a cable of the ambient temperature detection unit and the board structure, so as to maintain a gap between the cable and the board structure.

In one embodiment, the handle portion comprises an exposed first conductive part, which is electrically connected to the control circuit board and serves as a first electrode of the control circuit board; the detection portion is provided with a second conductive member, the detection portion is made of conductive material, and the second conductive member electrically connects the detection portion to the control circuit board so that the detection portion serves as a second electrode of the control circuit board, the first and second electrodes being either the positive or the negative electrode.

In one embodiment, the second conductive part is a conductive pin or metal shrapnel.

In one embodiment, the handle portion and the detection portion are coupled together, with adhesive material filling the coupling gap. A sealing isolation component is placed in the gap or within the detection portion to prevent the adhesive material from flowing into the detection portion.

In one embodiment, the food temperature detection units comprises at least two food temperature detection units, and in a same detection period, the control circuit board uses the lowest temperature detected by the at least two food temperature detection units as a detected temperature of the food in the period; or the control circuit board uses the average temperature detected by the at least two food temperature detection units as a detected temperature of the food in the period.

Based on the above objectives, one embodiment of this application provides a temperature measurement device for food, comprising:
A housing, wherein the housing comprises a detection portion for contacting the food, and the housing forms an installation cavity, with at least a part of the cavity defined in the detection portion;
A control circuit board, which is defined within the installation cavity;
A plurality of food temperature detection units, the food temperature detection units being defined within the housing, with the first temperature detection unit electrically connected to the control circuit board to transmit the signals detected by the first temperature detection unit to the control circuit board;
At least some of the food temperature detection units are separated from the control circuit board and form a thermal conduction structure with the inner wall of the detection portion.

According to the above embodiment of the temperature measurement device, it comprises a housing and a plurality of food temperature detection units arranged within the housing. The extension section of the housing is divided into a first longitudinal portion and a second longitudinal portion by a longitudinal reference plane passing through its central axis. The first and second longitudinal portions each correspond to at least one first temperature detection unit to collect temperature information from the respective regions of the first and second longitudinal portions. When the temperature measurement device is inserted into the food, the first and second longitudinal portions face different regions inside the food, and the first temperature detection units corresponding to each longitudinal portion can detect the temperature of those regions, thus acquiring temperature information from different regions to improve the detection of the lowest temperature inside the food.

### BRIEF DESCRIPTION OF THE DRAWINGS

FIG. 1 is a schematic diagram of the temperature measurement device inserted inside the food in one embodiment of the present application;

FIG. 2 is a schematic diagram of the first longitudinal portion and the second longitudinal portion of the temperature measurement device in one embodiment of the present application;

FIG. 3 is a schematic diagram of the distribution of the control circuit board and first temperature detection units in the cross-section of the detection portion in one embodiment of the present application;

FIG. 4 is a schematic diagram of the longitudinal cross-section of the temperature measurement device in one embodiment of the present application;

FIG. 5 is a schematic diagram of the longitudinal cross-section of the temperature measurement device in another embodiment of the present application;

FIG. 6 is a schematic diagram of the first and second sides of the control circuit board in the cross-section of the detection portion in one embodiment of the present application;

FIG. 7 is a schematic diagram of the first temperature detection units defined on the first and second sides of the control circuit board in the cross-section of the detection portion in one embodiment of the present application;

FIG. 8 is a exploded diagram of the embodiment shown in FIG. 4;

FIGS. 9 and 10 are schematic diagrams of some structures of the embodiment shown in FIG. 4 from different perspectives;

FIG. 11 is a schematic diagram of the rotational symmetry of the first temperature detection units around the center of the cross-section of the detection portion in one embodiment of the present application;

FIG. 12 is a exploded diagram of the embodiment shown in FIG. 5;

FIG. 13 is a schematic diagram of the distribution of the first temperature detection units in the cross-section of the detection portion in one embodiment of the present application

### DETAILED DESCRIPTION OF THE EMBODIMENTS

The present invention will be further described in detail below in conjunction with the accompanying drawings and specific embodiments. In the following embodiments, similar elements in different embodiments are denoted by associated and similar reference numerals. In these embodiments, many detailed descriptions are provided to facilitate better understanding of the present application. However, those skilled in the art will readily recognize that certain features can be omitted under different circumstances, or replaced by other components, materials, or methods. In some cases, certain operations related to this application are not explicitly shown or described in the specification, in order to avoid obscuring the core parts of the present application with excessive description. For those skilled in the art, detailed descriptions of these related operations are not necessary, and they can fully understand the relevant operations based on the description of the specification and their general technical knowledge.

Furthermore, the features, operations, or characteristics described in the specification may be combined in any suitable way to form various embodiments. The steps or actions described in the method may also be reordered or adjusted in a manner that is apparent to those skilled in the art. Therefore, the sequence presented in the specification and drawings is intended solely to clearly describe a particular embodiment and does not imply a mandatory sequence, unless it is explicitly stated that a specific sequence must be followed.

The serial numbers assigned to components in this document, such as “first,” “second,” etc., are used only to distinguish the described objects and do not imply any order or technical significance. The terms “connected” or “coupled” as used in this application, unless specifically stated otherwise, include both direct and indirect connections (or couplings).

This application provides a temperature measurement device for food, which can be inserted into the interior of the food during the cooking process to detect the internal temperature of the food, especially to accurately obtain the lowest internal temperature of the food. The food can be in any cooking state, including but not limited to steaming, boiling, baking, roasting, pan-frying, deep-frying, or any other form of heat treatment. Generally, the center temperature of the food is considered to be the lowest internal temperature. Since the temperature measurement device can measure multiple temperatures at different internal positions of the food, it has a significantly higher probability of reaching the actual center of the food compared to devices that measure only a single position or temperature. Among the multiple measured temperatures, the lowest valid temperature is very likely to be the actual center temperature or close to it. Therefore, the temperature measurement device has high accuracy and can effectively determine the doneness of the food. Of course, the temperature measurement device may also be directly placed in the environment to be measured to perform temperature detection. The measured environment includes but is not limited to cooking environments.

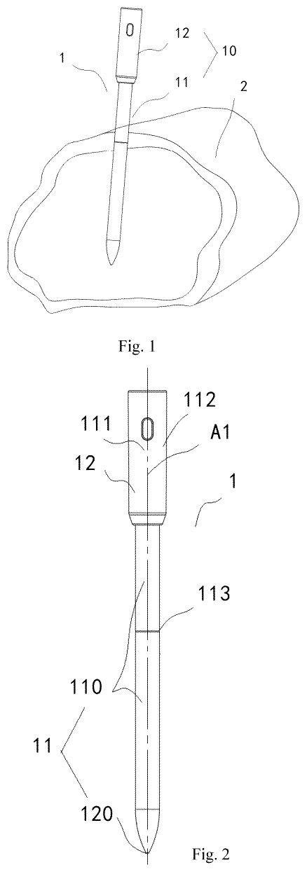

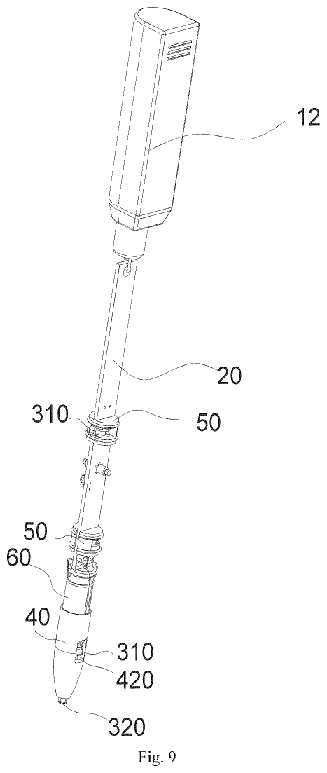

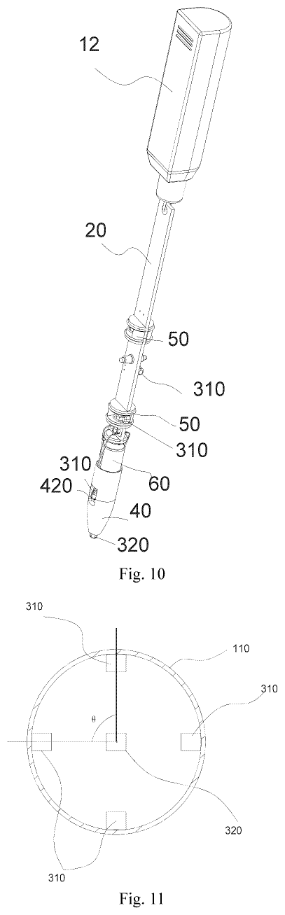

With reference to FIGS. 1 to 10, in some embodiments, the temperature measurement device 1 includes a housing 10, a control circuit board 20, and multiple food temperature detection units 30. Of course, when necessary, the temperature measurement device 1 may further include other related components, which can refer to those used in conventional temperature measurement devices.

The housing 10 is used to protect and mount the components that implement the functions of the temperature measurement device 1, such as the food temperature detection units 30 and/or other electronic components. In some embodiments, the housing 10 may have a cavity inside, and the functional components of the temperature measurement device 1 may be arranged within the internal cavity of the housing 10. In some embodiments, the housing 10 may have a single internal cavity in which functional components are arranged. In other embodiments, the housing 10 may include multiple cavities, with one or more functional components of the temperature measurement device 1 arranged in each cavity. One or more cavities may have any shape as long as they do not affect the installation of the functional components of the temperature measurement device 1.

In some embodiments, the housing 10 may enclose the functional components of the temperature measurement device 1 such that the housing 10 forms the outermost layer of the device and prevents external contact with the internal components. In other embodiments, the housing 10 may not completely enclose the functional components. For example, part of the food temperature detection units 30 may be defined outside the housing 10 to facilitate temperature measurement.

With reference to FIGS. 1 to 10, in some embodiments, the housing 10 includes a detection portion 11 for contacting the food. The detection portion 11 is in a strip-like structure and includes a front end portion 120 and an extension section 110 connected to the rear side of the front end portion 120. The longitudinal direction of the strip-like structure is the longitudinal direction of the detection portion 11 (as shown in the vertical direction in FIG. 2). The detection portion 11 forms a mounting cavity, at least a portion of which is defined within the detection portion 11. In some embodiments, the detection portion 11 may be made of a material with a certain hardness to maintain its shape and to provide protection for the internal functional components. The detection portion 11 may typically be made of thermally conductive materials such as metals or thermally conductive ceramics. In some embodiments, the metal material may be copper, nickel, or alloys such as stainless steel.

In some embodiments, one end of the detection portion 11 may be of a closed structure with a sharp front end portion 120 to facilitate insertion of the temperature measurement device 1 into the object to be measured. In some embodiments, the detection portion 11 may be formed as a strip-like structure, such as a tubular structure. In certain embodiments, the diameter of the front end of the strip-like detection portion 11 gradually decreases until it approaches zero, forming a closed sharp front end portion 120. In some embodiments, the detection portion 11 may be a hollow tubular structure with one end closed, in which functional components of the temperature measurement device 1 are mounted. In some embodiments, the cross-section of the hollow tubular detection portion 11 (i.e., the section perpendicular to the longitudinal direction) may be circular, elliptical, triangular, rectangular, polygonal, or of an irregular shape. In some embodiments, to facilitate handheld temperature measurement, one end of the detection portion 11 may be provided with a handle portion 12 for gripping. In some embodiments, the handle portion 12 is arranged away from the closed front end portion 120 of the detection portion 11.

The control circuit board 20 is arranged within the mounting cavity. The control circuit board 20 may include, but is not limited to, one or more circuit boards with control circuits. The control circuit board 20 controls the operation of the temperature measurement device 1. This control includes, but is not limited to, receiving temperature information collected by the food temperature detection units 30 and performing power-on or power-off control of the temperature measurement device 1. In some embodiments, the control may also include wired or wireless communication between the temperature measurement device 1 and other devices.

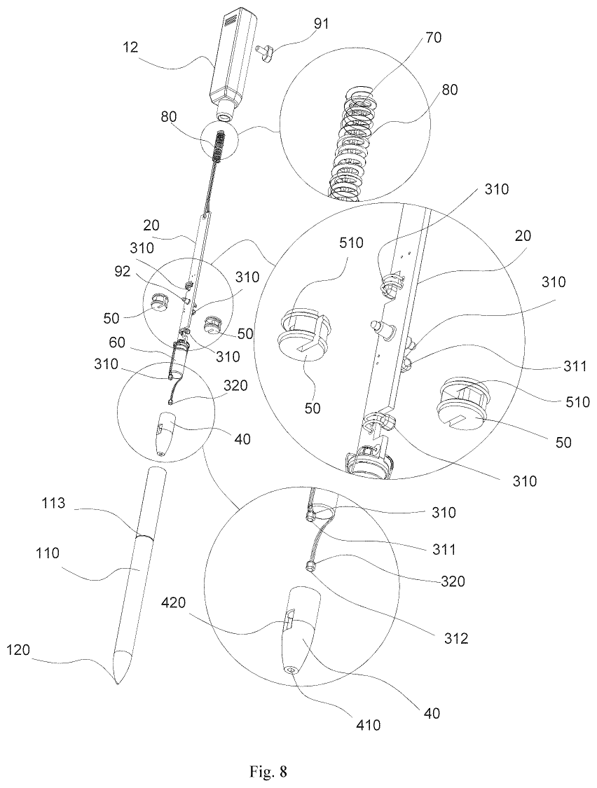

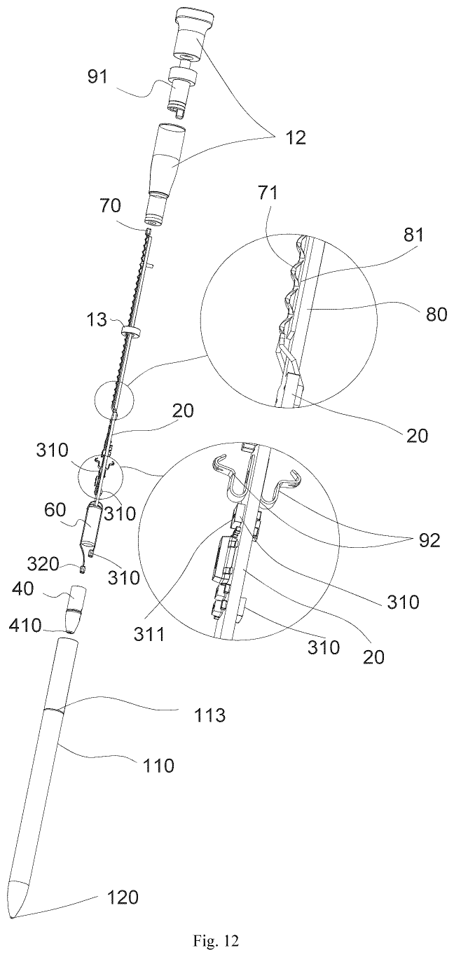

The food temperature detection unit 30 is defined on the housing 10 and includes a sensing end for acquiring temperature information (such as 311 and 312 in FIGS. 8 and 12). Some or all of the temperature detection units are first temperature detection units 310, which are arranged on the extension section 110. In some embodiments, the extension section 110 may have any shape. For example, the outer contour of the extension section 110 may include but is not limited to a cuboid, cylinder, truncated cone, truncated pyramid, or other irregular shapes. The extension section 110 may also have any dimension based on usage requirements.

The first temperature detection unit 310 is electrically connected to the control circuit board 20 to transmit the signal detected by the first temperature detection unit 310 to the control circuit board 20. In some embodiments, the food temperature detection unit 30 may be connected to or in contact with the detection portion 11 through any physical means. The physical connection methods described in this specification include but are not limited to threaded or bolted connection, riveting, interference fit, snap-fit, adhesive bonding, injection molding, welding, magnetic attraction, or any combination thereof.

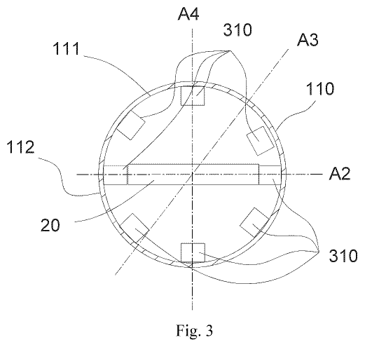

With reference to FIGS. 2 and 3, in some embodiments, the extension section 110 includes a first longitudinal portion 111 and a second longitudinal portion 112, which are divided by a longitudinal reference plane passing through the central axis of the extension section 110. The longitudinal reference plane may be any plane that passes through the central axis of the extension section 110, such as the planes A1, A2, A3, or A4 shown in FIGS. 2 and 3. The longitudinal reference plane is a virtual plane and may not be visible in appearance in some embodiments. In other embodiments, the position of the longitudinal reference plane may be indicated on the outer surface of the housing 10 using indicator lines or other markings.

In some embodiments, at least one first temperature detection unit 310 is arranged on each of the first longitudinal portion 111 and the second longitudinal portion 112, respectively, to collect temperature information from the regions corresponding to the first longitudinal portion 111 and the second longitudinal portion 112. When the temperature measurement device 1 is inserted into the interior of the food, the first longitudinal portion 111 and the second longitudinal portion 112 face different regions inside the food, and the first temperature detection units 310 corresponding to the first longitudinal portion 111 and the second longitudinal portion 112 detect the temperature of these different regions, thereby obtaining temperature information from different areas and improving the detection of the lowest internal temperature of the food.

Arranging at least one first temperature detection unit 310 on each of the first longitudinal portion 111 and the second longitudinal portion 112 enables more comprehensive spatial distribution of the temperature detection zones of the first temperature detection units 310 in three-dimensional space. Especially when more first temperature detection units 310 are distributed on the first longitudinal portion 111 and the second longitudinal portion 112, the temperature detection zones of the first temperature detection units 310 can be more evenly distributed around the periphery of the extension section 110, thereby allowing temperature detection in more regions of the food.

Furthermore, with reference to FIG. 3, in some embodiments, the control circuit board 20 is defined along the longitudinal direction of the detection portion 11. The longitudinal reference plane A2 is parallel to or coincides with the control circuit board 20. The control circuit board 20 includes a control circuit that is electrically connected to the food temperature detection units 30. Typically, the control circuit board 20 has a flat substrate, and the phrase “parallel to or coincides with the longitudinal reference plane A2” means that the longitudinal reference plane A2 is parallel to or coincides with one planar side of the substrate. Generally, the control circuit board 20 is a PCB. Of course, in other embodiments, it may also be an FPCB (flexible printed circuit board), and the substrate may be a flexible substrate.

In other embodiments, the longitudinal reference plane may also be perpendicular to or intersect with the plane where the control circuit board 20 is defined.

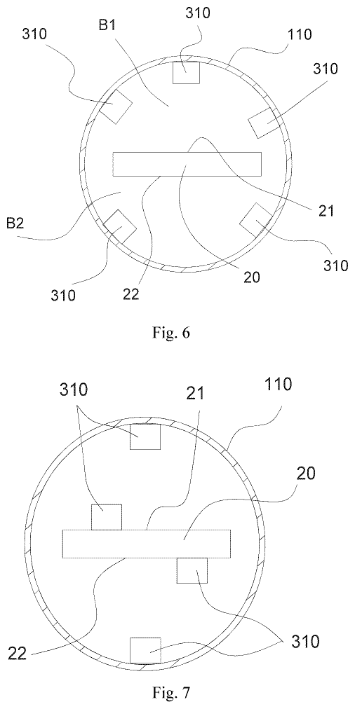

Further, with reference to FIGS. 3 and 6, in some embodiments, the control circuit board 20 includes a first surface 21 and a second surface 22 defined opposite each other. Electronic components forming the control circuit are defined on the first surface 21 and/or the second surface 22. The longitudinal reference plane is parallel to or coincides with either the first surface 21 or the second surface 22. In some embodiments, the first surface 21 and the second surface 22 are the two opposite sides of the substrate.

Furthermore, with reference to FIG. 6, in some embodiments, in the cross section of the detection portion 11, the projection of the sensing ends of a portion of the first temperature detection units 310 is within the projection range of a space B1 formed by extending from the first surface 21 in a direction away from the second surface 22. Another portion of the first temperature detection units 310 has sensing ends whose projection lies within the projection range of a space B2 formed by extending from the second surface 22 in a direction away from the first surface 21. In some embodiments, the spaces B1 and B2 are the spaces enclosed between the first surface 21 or second surface 22 and the corresponding housing 10 (e.g., the detection portion 110). In some embodiments, a projection within the space B1 or B2 also includes the case where the sensing end of the first temperature detection unit 310 is embedded in the housing 10 (such as the detection portion 110).

With reference to FIGS. 7 and 12, in some embodiments, a portion of the first temperature detection units 310 is defined on the first surface 21, and another portion is defined on the second surface 22. Of course, the first temperature detection units 310 may all be distributed on the first surface 21 and second surface 22 of the control circuit board 20, or some of the first temperature detection units 310 may be distributed outside the control circuit board 20. For example, as shown in FIG. 7, a portion of the first temperature detection units 310 may be provided on the housing 10 (such as the detection portion 110).

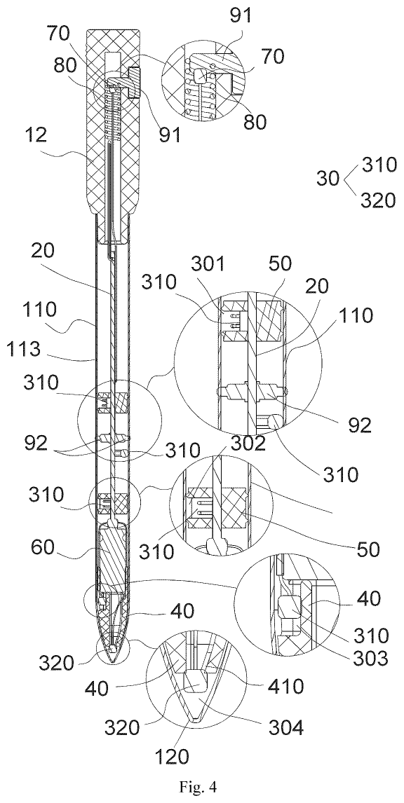

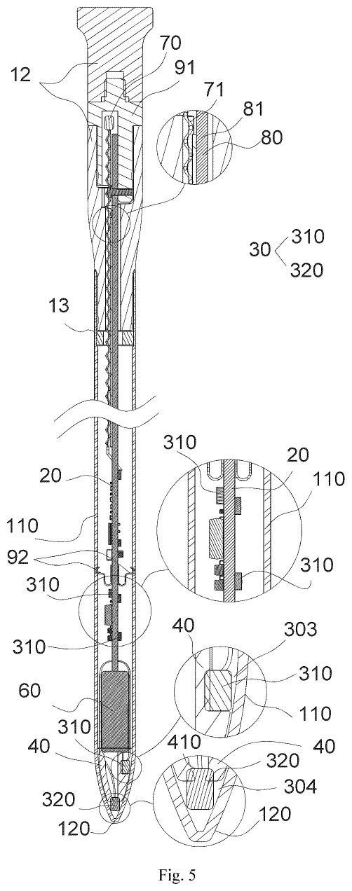

With reference to FIGS. 4 and 5, in some embodiments, at least two first temperature detection units 310 are provided and arranged along the longitudinal direction of the extension section 110. The at least two first temperature detection units 310 are defined at different longitudinal positions, thereby enabling temperature detection at different longitudinal positions of the extension section 110 and increasing the likelihood of detecting the lowest temperature inside the food. In this embodiment, the first temperature detection units 310 are distributed at different longitudinal positions along the extension section 110, as well as at different transverse positions (e.g., distributed across the first longitudinal portion 111 and the second longitudinal portion 112), thereby improving the uniformity of the distribution of the first temperature detection units 310 throughout the three-dimensional space. As a result, temperature detection across a broader range of regions is achieved, and more accurate readings closer to the actual center temperature of the food can be obtained.

With reference to FIG. 3, in some embodiments, at least two first temperature detection units 310 are provided for detecting temperature information corresponding to the first longitudinal portion 111, and/or at least two first temperature detection units 310 are provided for detecting temperature information corresponding to the second longitudinal portion 112. At least a portion of the first temperature detection units 310 are arranged such that their projections on the cross-section of the extension section 110 are completely staggered or partially non-overlapping with one another. This allows the temperature detection areas of the first temperature detection units 310 to be more evenly distributed around the peripheral regions of the extension section 110, thereby detecting the temperature of the food from different peripheral areas of the extension section 110.

Further, with reference to FIG. 11, in some embodiments, at least a portion of the projections of the first temperature detection units 310 are arranged circumferentially around the center of the cross-section of the extension section 110.

Further, still referring to FIG. 11, in some embodiments, the angle θ formed between projections of two adjacent first temperature detection units 310 and the center of the cross-section of the extension section 110 is within the range of 5° to 180°, for example, from 50° to 150°, and preferably from 85° to 95°, to achieve a more optimal distribution.

With reference again to FIG. 11, in some embodiments, the projections of multiple first temperature detection units 310 are arranged circumferentially around the center of the cross-section of the extension section 110. Among these multiple first temperature detection units 310, the angle θ formed between projections of two adjacent units and the center of the cross-section is equal. In this embodiment, the projections of the multiple first temperature detection units 310 are rotationally symmetrically arranged around the center of the cross-section, ensuring a more uniform temperature detection point distribution in the circumferential direction of the detection portion 11.

Referring to FIG. 11, in some embodiments, at least four first temperature detection units 310 are provided, where the projections of four first temperature detection units 310 are arranged circumferentially around the center of the cross-section of the extension section 110. Among these four first temperature detection units 310, the angle θ formed between projections of two adjacent units and the center of the cross-section is 90°. Naturally, when more first temperature detection units 310 are arranged around the center of the cross-section, the angle θ may be other values accordingly.

In some embodiments, all of the food temperature detection units 30 may be first temperature detection units 310, meaning that all of the food temperature detection units 30 are distributed on the extension section 110.

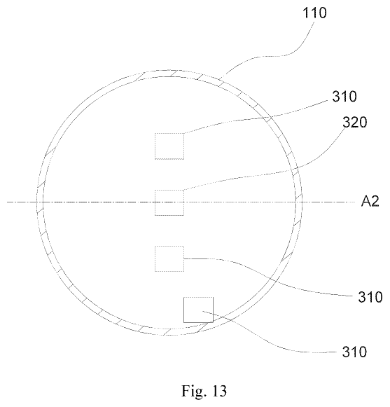

In other embodiments, the food temperature detection units 30 may also include additional temperature detection units defined outside of the extension section 110. With reference to FIGS. 4, 5, and 8-13, in some embodiments, at least a portion of the food temperature detection units 30 are second temperature detection units 320, which are defined on the front end portion 120 to detect the temperature of the region corresponding to the front end portion 120. The front end portion 120 is the leading end of the temperature measurement device 1 when inserted into the food 2. By providing a second temperature detection unit 320 on the front end portion 120, the diversity of internal temperature readings of the food 2 can be increased, thereby improving the overall temperature detection accuracy of the device.

With reference to FIGS. 4, 5, 11, and 13, in some embodiments, the projection of the second temperature detection unit 320 on the cross-section of the extension section 110 coincides with the center of the cross-section. Of course, in other embodiments, the projection of the second temperature detection unit 320 may be partially offset (also referred to as partially overlapping) or completely offset from the center of the corresponding cross-section. As used herein, “partially offset” refers to two objects having only a portion overlapping with each other.

On the other hand, with reference to FIGS. 4 and 5, in some embodiments, at least one food temperature detection unit 30 is individually defined within a housing cavity (such as elements 301, 302, 303, 304 in FIGS. 4 and 5). The cavity wall of the housing cavity isolates the food temperature detection unit 30 inside from other food temperature detection units 30, and forms a thermal insulation structure in the longitudinal direction of the detection portion 11, to reduce the transmission of heat from other regions along the longitudinal direction of the detection portion 11 to the food temperature detection unit 30 defined inside the housing cavity. This prevents the influence on the temperature measurement results of the food temperature detection unit 30 inside the housing cavity and thereby improves the accuracy of detection. The thermal insulation structure can be achieved using thermal insulation materials or structures. For example, in some embodiments, the thermal insulation material is an elastic and high-temperature-resistant material such as silicone, rubber, or resin. In some embodiments, thermal grease may be applied between the sensing end of the food temperature detection unit 30 and the inner wall of the detection portion 11 to further increase the contact area and improve the accuracy of temperature detection. In some embodiments, the thermal insulation structure may include but is not limited to a vacuum-insulated chamber.

Furthermore, in some embodiments, each food temperature detection unit 30 is individually defined in a separate housing cavity, so that each unit primarily detects the temperature of the region of the food 2 corresponding to its own position, avoiding heat transfer from other regions of the food 2 that might affect the measurement result. In other embodiments, a portion of the food temperature detection units 30 may be grouped within the same housing cavity, for example, when two or more detection units are positioned relatively close together.

In order to better isolate the influence of heat from other regions on the food temperature detection units 30 within the housing cavities, and with reference to FIGS. 4 and 5, in some embodiments, cavities 301, 302, 303, and 304 are thermally insulated in all areas of their cavity walls except for the region facing the detection portion 11. The phrase “except for the region facing the detection portion 11” refers to the side of the food temperature detection unit 30's sensing end that faces the inner wall of the detection portion 11. In this configuration, thermal isolation is provided not only in the longitudinal direction of the detection portion 11 but also in the lateral directions other than the direction facing the inner wall of the detection portion 11. The sensing end of the food temperature detection unit 30 remains exposed in the direction of the inner wall to ensure that the food temperature can be transmitted more directly and rapidly from the region facing the detection portion 11 to the temperature detection unit 30, enabling accurate temperature measurement.

Furthermore, the food temperature detection unit 30 may be mounted on the housing 10 using any feasible means. The term “any feasible means” refers to any installation method that does not conflict with the configurations described in the above embodiments, and such installation method can be applied accordingly.

With reference to FIGS. 4, 5, 8-10, and 12, in some embodiments, the apparatus further includes a front mounting base 40, which is defined within the detection portion 11 and at least partially defined inside the front end portion 120. At least one front accommodating cavity 304 (a type of the aforementioned accommodating cavity) is formed between the front end of the front mounting base 40 and the front end portion 120. Each front accommodating cavity 304 houses a second temperature detection unit 320. The front accommodating cavity 304 may be thermally insulated from one or more directions, for example, from all directions except the one where the sensing end of the second temperature detection unit 320 faces the detection portion 11.

The front mounting base 40 may be secured to the housing 10 using, but not limited to, adhesive bonding, snap fitting, welding, screwing, or with other fastening elements such as screws.

Furthermore, with reference to FIGS. 4, 5, 8-10, and 12, in some embodiments, the front end of the front mounting base 40 is provided with a first mounting groove 410, and part of the second temperature detection units 320 are defined inside the first mounting groove 410. A front accommodating cavity 304 is formed between the first mounting groove 410 and the front end portion 120.

Additionally, with reference to FIGS. 4, 5, 8-10, and 12, some embodiments disclose a mounting method for the first temperature detection unit 310. At least one lateral accommodating cavity 303 (a type of the aforementioned accommodating cavity) is formed between the peripheral side of the front mounting base 40 and the front end portion 120. Each lateral accommodating cavity 303 houses a first temperature detection unit 310. In this embodiment, both at least a portion of the first temperature detection units 310 and the second temperature detection units 320 can be mounted via the front mounting base 40, resulting in a more compact structure that helps reduce the outer diameter of the entire detection portion 11 and facilitates the insertion of the device into the food 2.

In some embodiments, on the cross-section of the extension section 110, the projection of at least one first temperature detection unit 310 defined in a lateral accommodating cavity 303 may fully overlap, partially overlap, or be completely offset from the projection of at least one second temperature detection unit 320 defined in a front accommodating cavity 304. When the projections are partially overlapped or completely offset, the combined detection range of the first and second temperature detection units 310 and 320 near the front end of the detection portion 11 can be expanded, which is beneficial for acquiring temperature information close to the minimum internal temperature of the food.

Furthermore, with reference to FIGS. 4, 5, 8-10, and 12, in some embodiments, the peripheral side of the front mounting base 40 is provided with at least one second mounting groove 420. Part of the first temperature detection units 310 are defined within the second mounting groove 420. A lateral accommodating cavity 303 is formed between the second mounting groove 420 and the extension section 110.

The configuration using the front mounting base 40 and the housing 10 (such as the detection portion 11) to mount the first temperature detection units 310 and second temperature detection units 320 is merely an example. In other embodiments, the first and/or second temperature detection units 310 and 320 may also be mounted onto the housing (such as the detection portion 11) using other structural arrangements.

Furthermore, with reference to FIGS. 4 and 8-10, in some embodiments, the apparatus further includes at least one intermediate mounting base 50. The intermediate mounting base 50 is defined within the extension section 110. It cooperates with the corresponding sidewall of the extension portion to form peripheral accommodating cavities 301 and 302 (types of the aforementioned accommodating cavity). Each peripheral accommodating cavity 301 or 302 houses a first temperature detection unit 310.

The peripheral accommodating cavities 301 and 302 may provide thermal insulation for the enclosed first temperature detection units 310 from at least one direction, for example, from all directions except the one where the sensing end of the first temperature detection unit 310 faces the detection portion 11.

The intermediate mounting base 50 may be secured to the housing 10 using, but not limited to, adhesive bonding, snap fitting, welding, screwing, or other fastening means such as screws.

With reference to FIGS. 4 and 8-10, in some embodiments, the peripheral side of the intermediate mounting base 50 may directly or indirectly abut against the wall of the detection portion 11 to provide structural support. This improves the mechanical strength of the detection portion 11 without adding extra components, ensuring that the detection portion 11 can be more easily inserted into the food 2 and preventing bending or deformation during insertion.

Furthermore, with reference to FIGS. 4 and 8-10, in some embodiments, the intermediate mounting base 50 is provided with a third mounting groove 510, with at least part of the first temperature detection units 310 defined inside the third mounting groove 510. A peripheral accommodating cavity 301 or 302 is formed between the third mounting groove 510 and the extension section 110. When the intermediate mounting base 50 is installed into the extension section 110, the extension section 110 or other components mounted on it cooperate with the third mounting groove 510 to form the peripheral accommodating cavities 301 and 302. This structure is simple and easy to install. Meanwhile, by providing different numbers of third mounting grooves 510 on the intermediate mounting base 50, one or more peripheral accommodating cavities can be formed.

Furthermore, with reference to FIGS. 4 and 8-10, in some embodiments, there are at least two intermediate mounting bases 50 arranged in the longitudinal direction of the extension section 110. A gap is formed between adjacent intermediate mounting bases 50, which may be used to accommodate other related components, such as the second conductive member 92 described later. The control circuit board 20 passes through the intermediate mounting bases 50 along the longitudinal direction of the extension section 110. The intermediate mounting base 50 may be provided with notches through which the control circuit board 20 passes. When the control circuit board 20 is engaged with the intermediate mounting base 50, the intermediate mounting base 50 can also serve as a support structure for the control circuit board 20, eliminating the need for separate fixing components or reducing the number of fixing components, thereby simplifying the structure and enabling the outer diameter of the detection portion 11 to be further reduced.

With reference to FIG. 4, in some embodiments, the number of intermediate mounting bases 50 is two, and they are respectively defined at both longitudinal ends of the control circuit board 20 to stabilize the control circuit board 20 from both ends and prevent disconnection caused by vibration or displacement. Of course, to further enhance the fixation of the control circuit board 20, additional fixing structures may be provided in addition to the intermediate mounting bases 50, such as welding, bonding, snap-fitting, screwing, or using other fixing components.

In other embodiments, the number of intermediate mounting bases 50 may also be one or more than two.

To achieve better thermal insulation, in some embodiments, at least the parts of the front mounting base 40 and/or the intermediate mounting base 50 that form the corresponding accommodating cavities are made of insulating materials. In some embodiments, such insulating materials include high-temperature-resistant silicone, rubber, or resin.

In other embodiments, no thermal insulation structure is provided around the food temperature detection units 30, and two or more of the food temperature detection units 30 are exposed within the same cavity.

In addition to directly or indirectly abutting the food temperature detection unit 30 against the detection portion 11, in some embodiments, holes are drilled into the detection portion 11, and the sensing ends of the food temperature detection units 30 are embedded into the holes. The space between the food temperature detection unit 30 and the detection portion 11 is filled with solder or adhesive, and the units are defined in place by welding or bonding. The surface is then polished to be flat and smooth, allowing the sensing end of the food temperature detection unit 30 to be in direct contact with the food for temperature measurement. Subsequent processing and surface treatment may be performed to ensure that the bonded surface between the detection portion 11 and the food temperature detection unit 30 is complete and food-safe. In some embodiments, the food temperature detection unit 30 may also be directly abutted inside the detection portion 11, and the outer tip of the detection portion 11 is then cut or polished until the food temperature detection unit 30 is exposed or nearly exposed at the tip, achieving rapid temperature measurement.

Furthermore, in some embodiments, to reduce the overall weight of the temperature measurement device 1 and avoid redundant readings caused by closely spaced temperature sensors, the number of food temperature detection units 30 may be less than or equal to fifteen. In some embodiments, to balance the trade-off between multi-point temperature data collection and device weight, the number of food temperature detection units 30 may range from three to fifteen. In some embodiments, the number may be three to ten. In some embodiments, it may be four to eight. In some embodiments, as shown in FIG. 4, the number of food temperature detection units 30 may be five. In some embodiments, as shown in FIG. 5, the number may be four.

In some embodiments, the food temperature detection unit 30 may be a thermocouple (TC), resistance temperature detector (RTD), thermistor, or any combination thereof. In some embodiments, to achieve fast temperature measurement, the food temperature detection unit 30 may be a thermocouple. The thermocouple is formed by joining the ends of two conductors made of different materials to form a closed circuit, where one end used directly for temperature measurement is the sensing end, and the other is the compensation end. In some embodiments, the food temperature detection unit 30 may be a negative temperature coefficient (NTC) type thermistor. The thermistor comprises a thermal probe (sensing end), leads, and the housing 10.

On the other hand, to enhance heat conduction between the food temperature detection unit 30 and the housing 10, in some embodiments, at least a portion of the food temperature detection unit 30 forms an elastic support structure to establish a thermal conduction structure with the extension section 110. This elastic support structure provides a buffering effect between the food temperature detection unit 30 and the extension section 110. Even if there is a positional shift between the food temperature detection unit 30 and the extension section 110 due to collision, prolonged use, or improper assembly, stable thermal conduction contact can still be maintained through the resilience of the elastic support structure. The thermal conduction contact between the food temperature detection unit 30 and the extension section 110 may be direct or indirect via other components or structures.

Specifically, in some embodiments, within the thermal conduction structure, the food temperature detection unit 30 may directly abut the inner wall of the detection portion 11, or thermal conduction material may be provided between the food temperature detection unit 30 and the inner wall of the detection portion 11. The food temperature detection unit 30, the thermal conduction material, and the detection portion 11 are in mutual contact. In some embodiments, the thermal conduction material in the thermal conduction structure may be a single substance or composed of two or more groups.

In some embodiments, the thermal conduction material includes but is not limited to thermal grease, thermal silicone, thermal rubber, thermal gel, thermal adhesive, thermal paste, thermal film, and the like.

In some embodiments, within the elastic support structure, the elasticity of the elastic component drives the food temperature detection unit 30 to abut against the thermal conduction material or the detection portion 11.

To achieve the elastic support structure, please refer to FIGS. 4, 5, 8-10, and 12. In some embodiments, the front mounting base 40 elastically supports the second temperature detection unit 320 and/or a portion of the first temperature detection units 310, thereby forming a thermal conduction structure between the second temperature detection unit 320 and/or the portion of the first temperature detection units 310 and the detection portion 11. In some embodiments, the intermediate mounting base 50 elastically supports the first temperature detection units 310 to form a thermal conduction structure between the first temperature detection units 310 and the extension section 110. In these embodiments, the front mounting base 40 and the intermediate mounting base 50 act as elastic members by virtue of the material properties themselves, providing elastic support force. In other embodiments, springs, compression springs, torsion springs, or similar elastic members may be used as elastic components of the elastic support structure. For example, in some embodiments, the elastic member exerts force directly or indirectly on the mounting base of the food temperature detection unit 30 (such as the front mounting base 40 or intermediate mounting base 50), thereby forming the elastic support structure. Alternatively, in other embodiments, the elastic member may exert force directly on the food temperature detection unit 30 to form the elastic support structure.

In other embodiments, at least a portion of the food temperature detection units 30 may be supported by a non-elastic support structure to form a thermal conduction structure with the extension section 110. For example, the food temperature detection units 30 may be pressed directly or indirectly against the extension section 110 by a non-elastic structure, such as by welding, adhesion, clamping, or fastening with fixtures (e.g., screws), to achieve the pressing effect.

On the other hand, in some embodiments, the thermal conductivity of the detection portion 11 along any direction on its outer wall (except the wall thickness direction) may be less than its thermal conductivity along the wall thickness direction. This configuration enables heat from the external region corresponding to the area of the detection portion 11 where the food temperature detection unit 30 is defined to be rapidly conducted to the food temperature detection unit 30, while preventing heat from other regions of the detection portion 11 from being conducted to the food temperature detection unit 30 and interfering with the temperature measurement result.

Specifically, in some embodiments, to accurately measure the temperature of the object under test, the thermal conductivity of the detection portion 11 in its longitudinal extension direction (i.e., the lengthwise direction) may be less than its thermal conductivity in the wall thickness direction. This arrangement minimizes heat conduction from other areas along the extension direction of the detection portion 11 to the food temperature detection unit 30, thereby ensuring that the temperature information obtained by the food temperature detection unit 30 corresponding to the measured region is sufficiently accurate and reliable.

Generally, the thinner the wall thickness, the faster the longitudinal temperature diffusion along the temperature measurement device 1, with relatively little effect on temperature diffusion along the wall thickness direction. For example, in some embodiments, the wall thickness of the detection portion 11 ranges from 0.3 mm to 0.8 mm (inclusive of the endpoints). Specifically, in some embodiments, the wall thickness is 0.5 mm. In some embodiments, the outer surface of the detection portion 11 may be threaded, which accelerates longitudinal temperature diffusion along the temperature measurement device 1 while minimally affecting temperature diffusion along the wall thickness direction.

Furthermore, please refer to FIGS. 5 and 12. In some embodiments, at least a portion of the food temperature detection units 30 are defined on the control circuit board 20, while at least another portion of the food temperature detection units 30 are separated from the control circuit board 20 and form thermal conduction structures with the inner wall of the extension section 110.

Further, please refer to FIGS. 4, 5, 8-10, and 12. In some embodiments, the extension section 110 includes a safety zone marking 113. The region from the front end of the front end portion 120 to the safety zone marking 113 defines the safety zone, and the food temperature detection units 30 are arranged within the range of the safety zone. In some embodiments, the safety zone marking 113 may be a line or a three-dimensional engraved mark with a color significantly different from other regions of the extension section 110 surface, used to indicate to the user the insertion depth of the temperature measurement device 1 into the measured object (e.g., food). Of course, the safety zone marking 113 may also adopt other marking methods capable of presenting marking information to the user, such as colors, patterns, or other visual effects. Since the safety zone is designed to be fully inserted into the food during use, and the temperature inside the food is lower than that of the external cooking environment, the high temperatures in the cooking environment (e.g., ovens over 200° C., BBQ grills over 500° C.) can be prevented from damaging the electronic components of the temperature measurement device 1. Additionally, the safety zone marking 113 can prevent damage to the front end portion 120 of the extension section 110 caused by the temperature measurement device 1 being inserted too deeply into the measured object, and can also help avoid operator burns. In some embodiments, the safety zone marking 113 is defined on the outer wall of the extension section 110. In some embodiments, the safety zone marking 113 may surround the outer wall of the extension section 110.

Further, please refer to FIGS. 4, 5, 8-10, and 12. Some embodiments further include a power supply battery 60, such as a rechargeable battery or a disposable battery. The power supply battery 60 is defined within the detection portion 11 and defined within the safety zone. The power supply battery 60 supplies power to various electrical components within the temperature measurement device 1. Of course, in other embodiments, the device may also include a power module electrically connected to the control circuit board 20. This power module may connect to an external power source (e.g., external 220V power or other supply), thereby enabling the electrical components inside the temperature measurement device 1 to be powered by the external power source.

Please refer again to FIGS. 4, 5, 8-10, and 12. In some embodiments, the control circuit board 20 is defined within the safety zone to ensure that during use, the control circuit board 20 is inside the food 2, thus avoiding damage to the control circuit board 20 caused by the high temperatures of the cooking environment. In some embodiments, along the longitudinal direction of the detection portion 11, the power supply battery 60 is defined at the front end of the control circuit board 20, ensuring that during use, the power supply battery 60 is positioned inside the food 2, avoiding damage from the high cooking temperatures. Moreover, placing the power supply battery 60 in front of the control circuit board 20 also helps increase the weight of the head portion of the detection portion 11, making it easier to insert the device into the food 2.

Further, please refer to FIGS. 4, 5, 8-10, and 12. Some embodiments further include an ambient temperature detection unit 70. The housing 10 includes a handle portion 12 connected to the rear end of the detection portion 11. The ambient temperature detection unit 70 is defined within the handle portion 12 and outside the safety zone. The ambient temperature detection unit 70 is electrically connected to the control circuit board 20 by soldering, with the solder joint defined within the safety zone. The ambient temperature detection unit 70 detects the temperature of the cooking environment and feeds the data back to the control circuit board 20 to assist in determining the cooking environment's temperature. In addition, in some embodiments, the cooking environment temperature information may also be used to help confirm the internal minimum temperature of the food 2, for example, as one of the factors to verify or calculate the internal minimum temperature of the food 2.

Further, some embodiments also include an antenna 80 electrically connected to the control circuit board 20 to enable wireless communication between the temperature measurement device 1 and other devices. The antenna 80 may implement wireless communication via Wifi, Bluetooth, cellular data, or other existing wireless communication technologies. Moreover, in other embodiments, the temperature measurement device 1 may also use a wired communication mode, connecting to other terminals or external antenna modules via cables.

Further, please refer to FIGS. 4 and 8-10. In some embodiments, the antenna 80 is defined in the handle portion 12, and the antenna 80 has a helical structure. Compared with antenna structures arranged linearly or in a zigzag pattern, designing the antenna 80 as a helical structure can ensure the antenna length within a smaller space. Moreover, the helical structure can form a hollow region. In some embodiments, the ambient temperature detection unit 70 can be defined passing through the hollow region of the helical antenna structure, thereby utilizing this hollow space to accommodate the ambient temperature detection unit 70. This improves the compactness of the entire antenna and ambient temperature detection unit assembly structure, facilitating a reduction of the overall outer diameter of the handle portion 12.

Of course, in other embodiments, the antenna 80 may be configured in other shapes and structures, such as linear, zigzag, planar board structures, or others. The ambient temperature detection unit 70 may also be arranged outside the antenna 80, for example, arranged laterally side-by-side or longitudinally front and back relative to the antenna 80.

Further, please refer to FIGS. 5 and 12. In some embodiments, the antenna 80 is defined in the handle portion 12 and has a planar board structure. An isolation member 81 is defined between the cable 71 of the ambient temperature detection unit 70 and the planar board antenna 80, so that a gap exists between the cable 71 and the antenna 80 to prevent the cable 71 from affecting the signal transmission and reception of the antenna 80. The isolation member 81 is made of an isolation ceramic or other material with a similar function.

Further, please refer to FIGS. 4, 5, 8-10, and 12. In some embodiments, the handle portion 12 includes an exposed first conductive member 91 electrically connected to the control circuit board 20, serving as a first electrode of the control circuit board 20. The detection portion 11 includes a second conductive member 92. The detection portion 11 is made of conductive material, and the second conductive member 92 electrically connects the detection portion 11 to the control circuit board 20, enabling the detection portion 11 to serve as a second electrode of the control circuit board 20. The first electrode and the second electrode correspond to one of the positive and negative poles. By using the first and second electrodes, electrical connection between the temperature measurement device 1 and the external environment can be conveniently realized, such as directing current to the control circuit board 20 for charging. Of course, in other embodiments, the first and second electrodes may be formed by components other than the detection portion 11 or may both be arranged on the handle portion 12 or the detection portion 11.

Additionally, in other embodiments, the temperature measurement device 1 may realize electrical connection to the external environment by other means, such as wireless charging coils.

Further, please refer to FIGS. 4 and 8-10. In some embodiments, the second conductive member 92 is a conductive pogo pin. Please also refer to FIGS. 5 and 12. In some embodiments, the second conductive member 92 is a metal spring sheet.

Further, please refer to FIGS. 4, 5, 8-10, and 12. In some embodiments, the handle portion 12 and the detection portion 11 are connected by an insertion fit, and the insertion gap is filled with an adhesive medium to achieve better sealing.

Further, please refer to FIGS. 5 and 12. In some embodiments, the insertion gap or the detection portion 11 is provided with a sealing isolation component 13 to block the adhesive medium from flowing into the interior of the detection portion 11. This prevents the adhesive medium from entering inside the handle portion 12 or detection portion 11, which could otherwise affect the function of other components.

On the other hand, some embodiments of the present application also provide another temperature measurement device 1 for food, comprising a housing 10, a control circuit board 20, and multiple food temperature detection units 30.

The housing 10 includes a detection portion 11 configured to contact the food. The housing 10 defines a mounting cavity, with at least a portion of the mounting cavity defined within the detection portion 11. The control circuit board 20 is defined within the mounting cavity. The food temperature detection units 30 are arranged on the housing 10, wherein a first temperature detection unit 310 is electrically connected to the control circuit board 20 to transmit signals detected by the first temperature detection unit 310 to the control circuit board 20.

Among these, at least a portion of the food temperature detection units 30 are spatially separated from the control circuit board 20 and thermally coupled to an inner wall of the detection portion 11 to better receive temperature information from the detection portion 11 via direct thermal conduction.

In the various embodiments described above, multiple food temperature detection units 30 are spatially distributed in a three-dimensional manner on the temperature measurement device 1, thereby achieving multi-point temperature measurement. This configuration can significantly increase the likelihood of measuring the core temperature of the food in a single insertion, regardless of the food's shape or the user's insertion depth. Consequently, the device can more accurately acquire the temperature at or near the food's core, assisting users in accurately judging the food's degree of doneness.

Further, some embodiments illustrate methods for determining the food temperature, though the structures of the present application are not limited to these methods. Specifically, when at least two food temperature detection units are provided, within the same judgment period (e.g., the same point in time or within the same time interval), the control circuit board 20 may use the lowest temperature detected by the food temperature detection units 30 as the detected temperature of the food for that period; alternatively, the control circuit board 20 may use the average temperature detected by the food temperature detection units 30 as the detected temperature of the food.

Specifically, in some embodiments, the normal temperature information excludes interference from abnormal temperature data and more accurately reflects the true temperature of the measured object. Abnormal temperature information may include temperature values that are excessively high and/or low compared to values from other food temperature detection units 30. Such abnormal data may arise from measurement area differences, environmental factors, or device faults, and do not represent the true temperature of the measured object, thereby interfering with the temperature measurement results. In some embodiments, the control circuit board 20 determines abnormal temperature information and normal temperature information based on temperature data from at least two food temperature detection units 30 measuring at least two different regions of the measured object. Of course, in some embodiments, the control circuit board 20 may determine the detected temperature of the food without excluding abnormal temperature data or without performing a separate abnormality determination step.

In some embodiments, temperature differences between adjacent food temperature detection units 30 can be evaluated based on temperature information from at least two (preferably more than two) temperature detection units measuring the object. As an example, a preset temperature difference threshold A (e.g., A=10° C., 20° C., 25° C., etc.) may be defined. When the temperature difference between the temperature reading of a given food temperature detection unit 30 and at least one of its two adjacent units exceeds the threshold A, the temperature reading of this unit 30 is classified as abnormal temperature information, while the adjacent units' readings are not classified as abnormal. If the temperature differences between the given unit 30 and both adjacent units are less than the threshold A, the temperature reading of this unit 30 is classified as normal temperature information. When a food temperature detection unit 30 has only one adjacent unit, if the temperature difference between them exceeds A, the temperature reading of this unit 30 is classified as abnormal; if the difference is less than A, it is classified as normal. In the case where only two temperature readings are available, if the difference between them exceeds the threshold, at least one of the two readings is classified as abnormal temperature information and the other as normal. In this case, it may be preset that the temperature reading from the unit closer to either the handle portion 12 or the front end portion 120 is classified as abnormal temperature information. Since the food temperature detection units 30 are arranged along the extension direction of the detection portion 11, temperature information from adjacent units corresponds to temperature data from adjacent regions of the measured object.

For instance, the temperature difference threshold is set as A1. When there are two food temperature detection units 30, if the temperature difference between the two temperature readings exceeds threshold A1, the temperature reading closer to either the handle portion 12 or the front end portion 120 is judged as an abnormal temperature, while the other temperature reading is considered normal. When there are three food temperature detection units 30, if the temperature difference between the middle food temperature detection unit 30 and either of its adjacent units exceeds A1, the temperature reading of the middle unit is judged as abnormal, while the adjacent units will not be deemed abnormal. If the temperature differences between the middle food temperature detection unit 30 and both adjacent units are smaller than A1, the middle unit's temperature reading is considered normal. For the food temperature detection unit 30 on the left, which has only one adjacent middle position unit, if the temperature difference between the left unit and the middle unit exceeds A1, the left unit's temperature reading is judged as abnormal. If the temperature difference is smaller than A1, the left unit's temperature reading is considered normal. The same method applies to the right side food temperature detection unit 30 as it does for the left side. For more than three food temperature detection units 30, the method of judgment remains the same as for the three-unit case and is not further elaborated here.

In some embodiments, one or more food temperature detection units 30 may be preset as key position detection units. The key position detection unit can be the sensor closest to the center of the measured object during temperature measurement, which best reflects the temperature at the center position of the measured object. The key position detection unit may be a food temperature detection unit 30 defined on the side wall of the detection portion 11, or a food temperature detection unit 30 defined at the front end portion 120 of the detection portion 11. In some embodiments, the setting of the key position detection units can be configured by the user according to instructions provided in the user manual, or preset by the product designer according to the product design principle. For example, if the manual or design principle indicates that the front end portion 120 is inserted into the center of the food, the key position detection unit can be set as the food temperature detection unit 30 defined at the front end portion 120. Alternatively, if the manual or design principle indicates that one or several food temperature detection units 30 on the side wall of the detection portion 11 are used to determine the temperature at the food center, then that unit or those units may be designated as key position detection units.

In some embodiments, when the key position detection unit(s) obtain abnormal temperature information due to device malfunction, improper operation, or other reasons, a prompt event may be generated, such as an error message, warning sound, or other alert. For multiple key position detection units, the prompt event can be triggered when all key position detection units obtain abnormal temperature information, or when any one or some specified key position detection units obtain abnormal temperature information.

After the user inserts the temperature measurement device 1 into the food, multiple food temperature detection units 30 measure temperature, and after filtering out abnormal temperature values, the lowest temperature value is taken as the core temperature of the meat. Due to the spatial distribution of the food temperature detection units 30 at certain angles, the device avoids the issue caused by the detection portion 11 diameter, which would otherwise limit measurement to only one side temperature. In some embodiments, since the food temperature detection units 30 are directly or indirectly closely attached to the metal tube, and each unit 30 is separated by individual accommodation cavities, external temperatures or temperatures from different positions will not be transmitted through the internal air of the temperature measurement device 1. Therefore, each food temperature detection unit 30 measures the temperature almost entirely at the point where it contacts the inner wall of the detection portion 11, enabling rapid and accurate reflection of the food temperature at the measurement point.

Various exemplary embodiments are described herein for illustrative purposes. However, those skilled in the art will recognize that modifications and changes may be made to these exemplary embodiments without departing from the scope of the present disclosure. For example, various operational steps and components used to perform these steps can be implemented differently depending on the particular application or any number of cost functions related to system operation (e.g., one or more steps may be omitted, modified, or combined with other steps).

Although the principles of the present disclosure have been illustrated by various embodiments, many modifications to structures, arrangements, proportions, elements, materials, and components that are particularly suited to specific environments and operational requirements can be made without departing from the principles and scope of the present disclosure. Such modifications and other changes or variations are intended to be included within the scope of this disclosure.

The foregoing detailed description has been given with reference to various embodiments. However, those skilled in the art will recognize that numerous modifications and variations can be made without departing from the scope of the present disclosure. Therefore, the description herein is intended to be illustrative rather than restrictive, and all such modifications are intended to fall within the scope of the present disclosure. Similarly, the advantages, other benefits, and solutions to problems discussed above with respect to various embodiments should not be construed as critical, essential, or required. The terms “comprising” and any of its variants used herein are intended to be non-exclusive, such that the recitation of elements, processes, methods, articles, or apparatuses is not intended to exclude other elements not explicitly recited or that do not belong to such processes, methods, systems, articles, or apparatuses. Furthermore, the terms “coupled” and any variants thereof as used herein refer to physical connection, electrical connection, magnetic connection, optical connection, communication connection, functional connection, and/or any other form of connection.

Those skilled in the art will recognize that numerous changes may be made in the details of the above-described embodiments without departing from the fundamental principles of the invention. Accordingly, the scope of the invention should be determined by the appended claims.

1. A temperature measurement device for food, wherein comprising,
a housing, comprising a detection portion configured to contact the food, the housing forming a mounting cavity, at least a portion of the mounting cavity is defined in the detection portion; the detection portion having an elongated structure, comprising a front end portion and an extending section connected to a rear side of the front end portion;
a control circuit board defined in the mounting cavity;
a plurality of food temperature detection units defined in the housing, the food temperature detection units having sensing ends for collecting temperature information, at least a portion of the food temperature detection units are first temperature detection units defined on the extending section; the first temperature detection units are electrically connected to the control circuit board to transmit signals detected by the first temperature detection units to the control circuit board; and
wherein the extending section is divided by a longitudinal reference plane passing through a center line thereof into a first longitudinal portion and a second longitudinal portion, and at least one first temperature detection unit is defined in the first longitudinal portion and at least one first temperature detection unit is defined in the second longitudinal portion to collect temperature information corresponding to the regions of the first longitudinal portion and the second longitudinal portion respectively.

2. The temperature measurement device according to claim 1, wherein the control circuit board is longitudinally arranged along the detection portion, the longitudinal reference plane is parallel or coincident with the control circuit board, and the control circuit board comprises a control circuit electrically connected to the food temperature detection units.

3. The temperature measurement device according to claim 2, wherein the control circuit board comprises a first surface and a second surface opposite to each other, electronic components of the control circuit are defined on the first surface and/or the second surface, and the longitudinal reference plane is parallel or coincident with the first surface or the second surface.

4. The temperature measurement device according to claim 3, wherein in a cross-section of the detection portion, projections of sensing ends of a portion of the first temperature detection units are within a projection range of a space extending from the first surface toward a direction away from the second surface, and projections of sensing ends of another portion of the first temperature detection units are within a projection range of a space extending from the second surface toward a direction away from the first surface.

5. The temperature measurement device according to claim 3, wherein a portion of the first temperature detection units are definedly mounted on the first surface, and another portion of the first temperature detection units are definedly mounted on the second surface.

6. The temperature measurement device according to claim 1, wherein the first temperature detection units comprise at least two first temperature detection units arranged longitudinally along the extending section, and at least two of the first temperature detection units are defined at different positions along the longitudinal direction.

7. The temperature measurement device according to claim 1, wherein the first temperature detecting units for detecting the temperature information of the region corresponding to the first longitudinal portion are at least two, and/or the first temperature detecting units for detecting the temperature information of the region corresponding to the second longitudinal portion are at least two, and at least part of the first temperature detecting units are completely staggered or not completely overlapped in projection in the cross section of the extension section.

8. The temperature measurement device according to claim 1, wherein at least part of the projections of the first temperature detecting units are arranged around the center of the cross section of the extension section.

9. The temperature measurement device according to claim 8, wherein in the cross section of the extension section, the projections of two adjacent first temperature detecting units and the center of the cross section form a central angle, and the central angle is in a range of 85°-95°.

10. The temperature measurement device according to claim 8, wherein in the cross section of the extension section, multiple projections of the first temperature detecting units are arranged around the center of the cross section, and the central angles formed between any two adjacent projections of the first temperature detecting units and the center of the cross section are equal.

11. The temperature measurement device according to claim 8, wherein a number of the first temperature detecting units is at least four, and in the cross section of the extension section, the projections of four first temperature detecting units are arranged around the center of the cross section, and the central angles formed between any two adjacent projections of the first temperature detecting units and the center of the cross section is 90°.

12. The temperature measurement device according to claim 1, wherein at least part of the food temperature detection units are second temperature detecting units, and the second temperature detecting units are arranged at the front end portion to detect the temperature of the region corresponding to the front end portion.

13. The temperature measurement device according to claim 12, wherein in the cross section of the extension section, the projection of the second temperature detecting units coincides with the center of the cross section.

14. The temperature measurement device according to claim 12, wherein at least one of the food temperature detection units is individually arranged in a housing cavity, and cavity wall of the housing cavity isolates the at least one of the food temperature detection units inside from the other food temperature detection units, and forms a thermal isolation structure in the longitudinal direction of the detection portion to reduce heat transmission from other regions along the longitudinal direction of the detection portion to the at least one of the food temperature detection units defined inside the housing cavity.

15. The temperature measurement device according to claim 14, wherein except for a region facing the detection portion, the cavity walls of other regions of the housing cavity form the thermal isolation structure for the food temperature detection units therein.

16. The temperature measurement device according to claim 14, further comprising a front end mounting base defined inside the detection portion, with at least a part of the front end mounting base defined within the front end portion, wherein at least one front accommodating cavity is formed between the front end of the front end mounting base and the front end portion, and one second temperature detecting unit is arranged in each front accommodating cavity.

17. The temperature measurement device according to claim 16, wherein at least one lateral accommodating cavity is formed between a peripheral side of the front end mounting base and the front end portion, and one first temperature detecting unit is arranged in each lateral accommodating cavity.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. A temperature measurement device for food, wherein comprising: a housing, the housing comprising a detection portion for contacting food, the housing forming a mounting cavity, at least a portion of the mounting cavity being defined in the detection portion;
a control circuit board arranged in the mounting cavity;
multiple food temperature detection units arranged in the housing, first temperature detection units electrically connected to the control circuit board to transmit signals detected by the first temperature detection units to the control circuit board; and
wherein at least a portion of the food temperature detection units are separated from the control circuit board and form a thermal conduction structure with an inner wall of the detection portion.
